(19) United States
(12) Patent Application Publication
(10) Pub. No.: US 2001/0028676 A1
(43) Pub. Date: Oct. 11, 2001

(54) Multi-path detecting circuit and system

(76) Inventor: Michihiro Ohsuge, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/828,237

(22) Filed: Apr. 9, 2001

(30) Foreign Application Priority Data
Apr. 7, 2000 (JP) 106558/2000

(51) Int. Cl. H04K 1/00; H04B 15/00; H04L 27/30

(52) U.S. Cl. 375/148; 375/150; 375/152

(57) ABSTRACT

A matched filter 11 for receiving received data input is connected via a matched filter to a short period delayed profile averaging part 12 and thence to a long period delayed profile averaging part 13. The output of the short period delayed profile averaging part 12 is inputted via a threshold checking part 16 to a finger timing determining part 18. The output of the long period delayed profile averaging part 13 is inputted via a correlation peak retrieving part 17 to a finger timing determining part 18.

### BACKGROUND OF THE INVENTION

This application claims benefit of Japanese Patent Application No. 2000-106558 filed on Apr. 7, 2000, the contents of which are incorporated by the reference.

The present invention relates to multi-path detecting circuits and, more particularly, to multi-path detecting circuits and method used for CDMA (spread spectrum) systems.

A multi-path detecting circuit or a path timing detecting circuit used for a CDMA receiver usually performs computation concerning correlation between received signal and spread code, thus making propagation channel delayed profile measurement for delayed profile correlation peak position detection. Such multi-path detecting circuits or related techniques are disclosed for instance, as “CDMA Multi-path Search Method and CDMA Signal Receiver” in Japanese Patent Laid-Open No. 9-181704, as “Receiver of Direct Spread CDMA Transmitting System” in Japanese Patent Laid-Open No. 10-190522, as “CDMA Mobile Communication Receiver” in Japanese Patent Laid-Open No. 10-271034, as “Reception Timing Detecting Circuit for CDMA Receiver” in Japanese Patent Laid-Open No. 10-32523, as “Long Code Searching Method in DS-CDMA Inter-Base Station Asynchronous Cellular System” in Japanese Patent Laid-Open No. 11-205864 and as “Spread Spectrum Receiver” in Japanese Patent Laid-Open No. 11-4213.

The shape of delayed profile at a mobile terminal varies with the movement of the terminal. FIGS. 6(A) and 6(B) show examples of delayed profile variations. In the Figures, the ordinate (or vertical axis) is taken for the correlated power level, and the abscissa (or horizontal axis) is taken for the propagation delay time. In the example of FIG. 6(A), mainly only the path level is varied due to fading, and the path timing is not substantially changed. In this case, it is better for obtaining satisfactory characteristics to average the delayed profile for a relatively long period of time so as to obtain sufficient level variation averaging. With an insufficient averaging time, usually pathes of high average received power levels are not accurately determined particularly in cases where the number of detected pathes is greater than the number of the receiver fingers.

On the other hand, a case may arise that a wave having been blocked by a building, for instance, suddenly appears. FIG. 6(B) illustrates such a case. AS shown, a path which has been absent in the status in the upper part of the Figure, suddenly appears as shown in the middle part of the Figure, or a path having been present in the status in the middle part of the Figure, suddenly disappears as in the lower part of the Figure. In this case, the long period delayed profile averaging as in the above case results in too long time until recognition of a new path, thus disabling the follow-up of the path variation as in FIG. 6(B).

As shown above, the short and long time delayed profile averaging cases have their own merits and demerits. It is possible, as shown in the above Japanese Patent Laid-Open No. 10-271034, to adaptively change the delayed profile averaging time in dependence on the path variation status. In this case, however, problems of averaging time check errors and checking process delay are posed.

### SUMMARY OF THE INVENTION

To solve the above problems, it is an object of the present invention to provide a multi-path detecting circuit suitable for a CDMA receiver capable of fast and accurate multi-path detection.

According to an aspect of the present invention, there is provided a multi-path detecting circuit for detecting multi-path timings by measuring a delayed profile of a propagation channel, comprising a short period delayed profile averaging part and a long period delayed profile averaging part for averaging the delayed profile in two different, i.e., short and long, cycle periods, respectively.

The multi-path detecting circuit further comprises a threshold checking part for receiving the output of the short period delayed profile averaging part and checking whether the output exceeds a threshold value, a correlation peak retrieving part for receiving the output of the long period delayed profile averaging part and retrieving upper rank correlation peaks for every correlation profile, and a finger timing determining part for receiving the outputs of the correlation peak retrieving part and the threshold checking part. The multi-path detecting circuit further comprises a long period profile storing part for storing the output of the long period delayed profile averaging part. The multi-path detecting circuit further comprises a subtracter provided between the short period delayed profile averaging part and the threshold checking part, for extracting the difference of the short period averaged delayed profile from the long period averaged delayed profile stored in the long period delayed profile storing part for each short period averaged delayed profile. The short period is set to about 10 msec., and the long period is set to about 100 msec. The multi-path detecting circuit is used for a CDMA receiver having a RAKE finger part, to which the timing output from the finger timing determining part is supplied.

According to another aspect of the present invention, there is provided a multi-path detecting system for determining pathes to be allotted to RAKE finger on the basis of combination of a long period averaged delayed profile for averaging level variations due to fading and a short period averaged delayed profile for fast detecting new path generation.

According to other aspect of the present invention, there is provided a multi-path detecting system comprising: a matched filter for outputting correlation value data concerning spread code and received signal; a short period delayed profile averaging part for averaging delayed profile of measured channel path; a long period delayed profile averaging part for power averaging the short period averaged delayed profile data for a long period and storing the power averaged data to a long period delayed profile storing part; a subtracter for subtracting a difference from the stored long period averaged delayed profile whenever the short period averaged delayed profile is outputted; a threshold checking part for outputting data of pathes to be added when the difference from the subtracter exceeds a predetermined threshold value; a finger timing determining part for adding path allotment to RAKE finger part on the basis of the output of the threshold checking part; a correlation peak retrieving part for retrieving correlation peaks up to upper rank N for every long period delayed profile storing part output; a finger timing determining part for alloting the path timings to the RAKE finger part; and a RAKE synthesizing part for synthesizing data received in the individual fingers with each multi-path.

According to further aspect of the present invention, there is provided a multi-path detecting system comprising steps of: executing instantaneous delayed profile profile measurement by calculating correlation of spread codes and received signal to one another; averaging the delayed profile for time such as to be able to smooth noise; checking as to whether the time has elapsed; outputting the result of the short period averaging after the averaging for the time; calculating the difference of the long period averaged delayed profile correlation data from the short period averaged data obtained for each sample; checking, for each sample, as to whether a predetermined threshold value has been exceeded and, when the threshold value has been exceeded, outputting M sample numbers in excess of the threshold value; alloting newly detected new pathes the fingers presently out of use or in the order of lower reception power level fingers; averaging the short period averaged delayed profile for longer period of time; checking as to whether the longer time has elapsed; storing the long period averaged delayed profile data for every averaging period of the longer time; selecting upper N to M rank correlation peaks of the stored profile; and alloting these timings to the fingers.

According to still other aspect of the present invention, there is provided a CDMS receiver using the above multi-path detecting circuit comprising: an antenna part for receiving radio transmitted data; a high frequency signal receiving circuit for frequency converting the received signal; an A/D converter part for converting the output of the high frequency signal receiving circuit from analog signal to digital signal; the multi-path detecting circuit for receiving signal from the A/D converter part, detecting multi-path timing and determining the detected multi-path timing as reception timing input to RKE finger part; and a RAKE synthesizing part for synthesizing data from the RAKE finger part as received at each timing.

According to other aspect of the present invention, there is provided a CDMS receiver using the above multi-path detecting system comprising: an antenna part for receiving radio transmitted data; a high frequency signal receiving circuit for frequency converting the received signal; an A/D converter part for converting the output of the high frequency signal receiving circuit from analog signal to digital signal; the multi-path detecting circuit for receiving signal from the A/D converter part, detecting multi-path timing and determining the detected multi-path timing as reception timing input to RKE finger part; and a RAKE synthesizing part for synthesizing data from the RAKE finger part as received at each timing.

Other objects and features will be clarified from the following description with reference to attached drawings.

### BRIEF DESCRIPTION OF THE DRAWINGS

FIG. 1 is a block diagram showing a preferred embodiment of the multi-path detecting circuit according to the present invention;

FIG. 2 is a block diagram showing a CDMS receiver using the multi-path detecting circuit 10 shown in FIG. 1;

FIG. 3 is a flow chart showing the operation of the multi-path detecting circuit according to the present invention;

FIG. 4 is a block diagram showing the construction of the different embodiment;

FIG. 5 is a flow chart for describing the operation of the multi-path detecting circuit 10′ shown in FIG. 4; and

FIGS. 6(A) and 6(B) show examples of delayed profile variations.

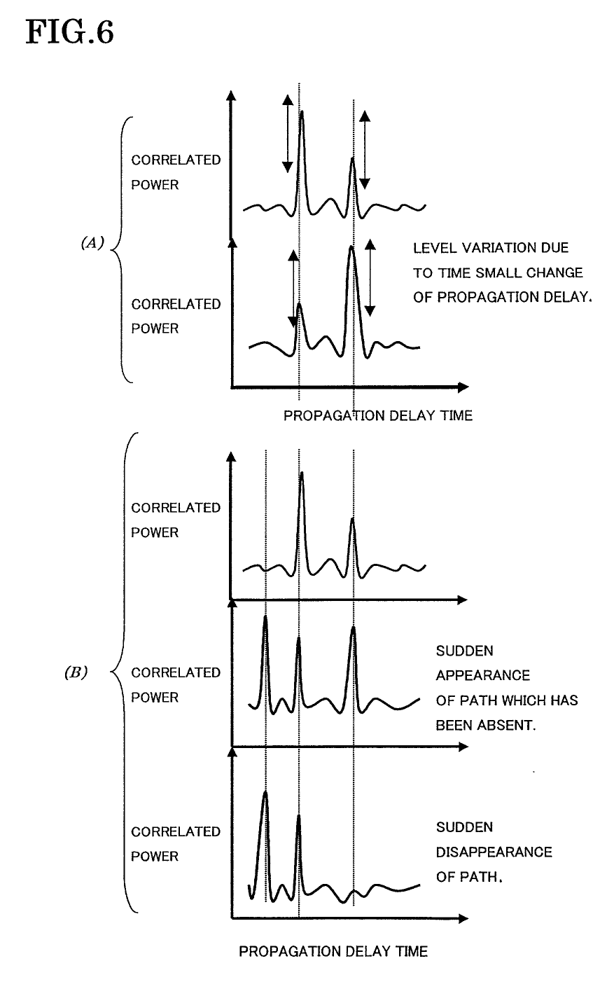

### PREFERRED EMBODIMENTS OF THE INVENTION

Preferred embodiments of the present invention will now be described with reference to the drawings.

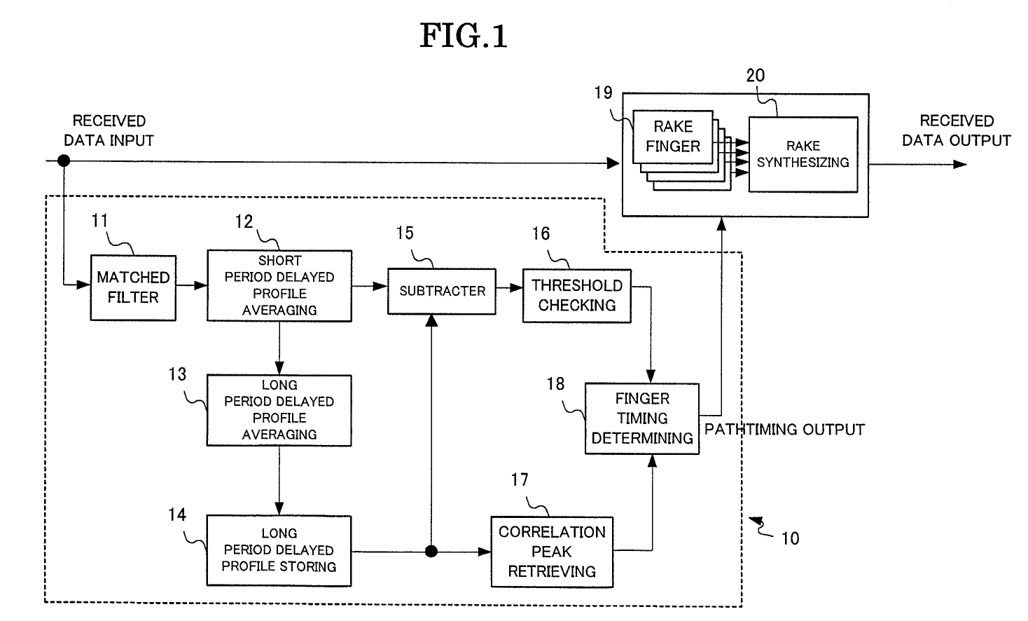

FIG. 1 is a block diagram showing a preferred embodiment of the multi-path detecting circuit according to the present invention. The multi-path detecting circuit 10 according to the present invention comprises a matched filter 11, a short period delayed profile averaging part 12, a long period delayed profile averaging part 13, a long period delayed profile storing part 14, a subtracter 15, a threshold checking part 16, a correlation peak retrieving part 17 and a finger timing determining part 18. As shown in FIG. 1, the output of the multi-path detecting circuit 10 is inputted together with received data input to an RAKE finger part 19. The output of the RAKE finger part 19 is inputted to an RAKE synthesizing part 20, which provides received data output.

In the multi-path detecting circuit 10 shown in FIG. 1, the received data input is inputted to the matched filter 11. The matched filter 11 is connected to the short delayed profile period averaging part 12. The short delayed profile period averaging part 12 is connected to the long delayed profile period averaging part 13 and also to the subtracter 15. The long delayed profile period averaging part 13 is connected via the long period delayed profile storing part 14 to the subtracter 15 and also to the correlation peak retrieving part 17. The subtracter 15 is connected via the threshold checking part 16 to the finger timing determining part 18. The correlation peak retrieving part 17 is also connected to the finger timing retrieving part 18.

The multi-path detecting circuit shown in FIG. 1 features that it determines pathes to be allotted to RAKE finger by using in combination a long period averaged delayed profile for averaging level variations due to fading and a short period averaged delayed profile for fast detecting new path generation.

In the multi-path detecting circuit 10 shown in FIG. 1, the matched filter 11 outputs correlation value data concerning spread code and received signal. The short period delayed profile averaging part 12 thus averages delayed profile of measured channel path for such a short period that noise can be averaged. The long period delayed profile averaging part 13 further power averages the short period averaged delayed profile data for a long period, and outputs the power averaged data to the long period delayed profile storing part 14. The subtracter 15 subtracts a difference from the stored long period averaged delayed profile whenever the short period averaged delayed profile is outputted. When the difference exceeds a predetermined threshold value, the threshold checking part 16 outputs data of pathes to be added.

The finger timing determining part 18 adds path allotment to the RAKE finger part 19 according to the output of the threshold checking part 16. The correlation peak retrieving part 16 retrieves correlation peaks up to upper rank N for every long period delayed profile storing part output. The part 18 allots these path timings to the RAKE finger part 19. N stands for number of fingers. The above operation is performed repeatedly for every two delayed profile averaging periods to estimate the multi-path timing of the propagation channel. The RAKE synthesizing part 20 synthesizes data received in the individual fingers with each multi-path. Thus, at such a low moving rate time as when the terminal user is walking, level variations due to low rate fading can be sufficiently averaged by the delayed profile averaging over the long period. It is thus possible to select pathes in the higher reliability order. In addition, even at the time of fast path position changes due to shadowing or like courses, it is possible to perform fast path allotting to the RAKE finger part by the estimation according to the short period averaged delayed profile data. Thus, it is possible to obtain multi-path detection reliability improvement independently of the moving status of the terminal. Furthermore, since the path selection according to the short period averaged delayed profile data requires only subtraction and threshold checking, it is possible to reduce the circuit scale and the current consumption.

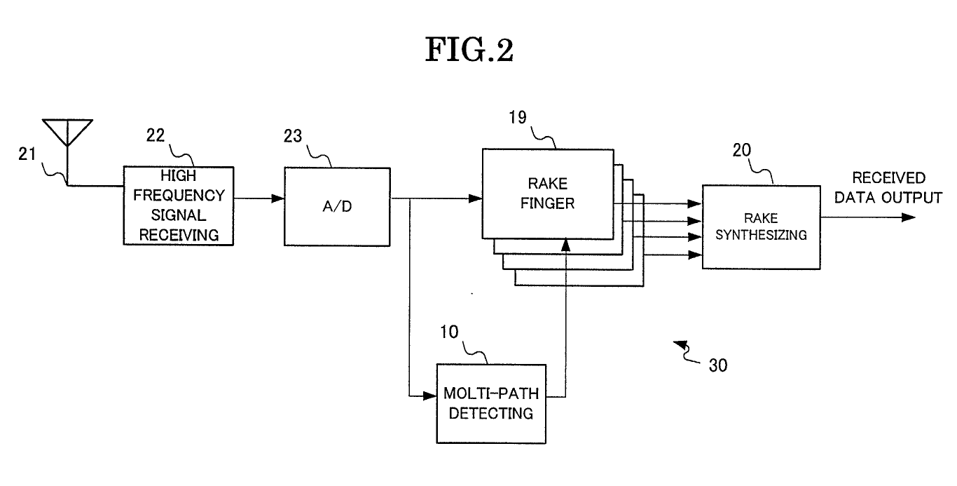

FIG. 2 is a block diagram showing a CDMS receiver using the multi-path detecting circuit 10 shown in FIG. 1. The CDMA receiver 30 comprises an antenna part 21, a high frequency signal receiving circuit part 22 and an A/D (analog-to-digital) converter 23 as well as the RAKE finger part 19, the RAKE synthesizing part 20 and the multi-path detecting part 10 shown in FIG. 1. The antenna part 21 receives radio transmitted data. The high frequency signal receiving circuit (i.e., radio part) 22 frequency converts (i.e., down-converts) the received signal. The A/D converter part 23 converts the output of the circuit 22 from analog signal to digital signal. The multi-path detecting circuit 10 receives signal from the A/D converter part 23, and detects multi-path timing by measuring the delayed profile of the propagation channel. The output of the circuit 10 is used as reception timing input to the RKE finger part 19. The RAKE synthesizing part 20 synthesizes data from the RAKE finger part 19 as received at each timing.

The operation of the CDMA receiver will now be described with reference to the multi-path detecting circuit 10 shown in FIG. 1. As noted above, the multi-path detecting circuit 10 comprises the matched filter 11, which outputs the data of correlation of spread codes and received signal to one another. The short period delayed profile averaging part 12 averages the delayed profile of the propagation channel as measured by the matched filter 11 for such a short period of time as to be able to smooth noise. The long period delayed profile averaging part 13 power averages the short period averaged delayed profile data for a longer period of time, and outputs the resultant data to the long period delayed profile storing part 14. The subtracter 15 extracts the difference from the stored long period averaged delayed profile for every short period averaged delayed profile output.

When the difference from the long period averaged delayed profile exceeds a predetermined threshold value, the threshold checking part 16 determines that a new path has been generated, and outputs data of pathes to be added. According to this output, the finger timing determining part 18 adds path allotment to the fingers. In addition, the correlation peak retrieving part 17 retrieves correlation peaks up to upper rank N for every long period delayed profile output. The part 18 allots these path timings to the RAKE finger part 19. The above operation is executed for every two delayed profile averaging periods, thus estimating the multi-path timing of the propagation channel.

The multi-path timing data thus obtained is inputted (i.e., supplied) to the RAKE finger part 19 shown in FIG. 2. With the construction as described above, at a low moving rate time such as when the terminal user is walking, the multi-path detecting circuit 10 can obtain sufficient averaging of level variations due to slow fading by long period averaging the delayed profile. It is thus possible to obtain highly reliable path selection. At a high rate moving time, the path positions are fast changed due to shadowing or like cases. Again in this case, it is possible to fast add path allotment to the fingers by the estimation according to the short period delayed profile. It is thus possible to obtain multi-path detection reliability improvement independently of the moving status of the terminal. Furthermore, since the path selection according to the short period averaged delayed profile data requires only subtraction and threshold checking, it is possible to reduce the circuit scale and the current consumption.

The matched filter 11 shown in FIG. 1 is well known to the person skilled in the art as delayed profile measuring means, and its detailed construction and operation are not described. It is possible to replace this part with a sliding correlator. The RAKE finger part 19 and the RAKE synthesizing part 20 are also well known to the person skilled in the art and have no direct bearing on the present invention, and their detailed construction and operation are not described.

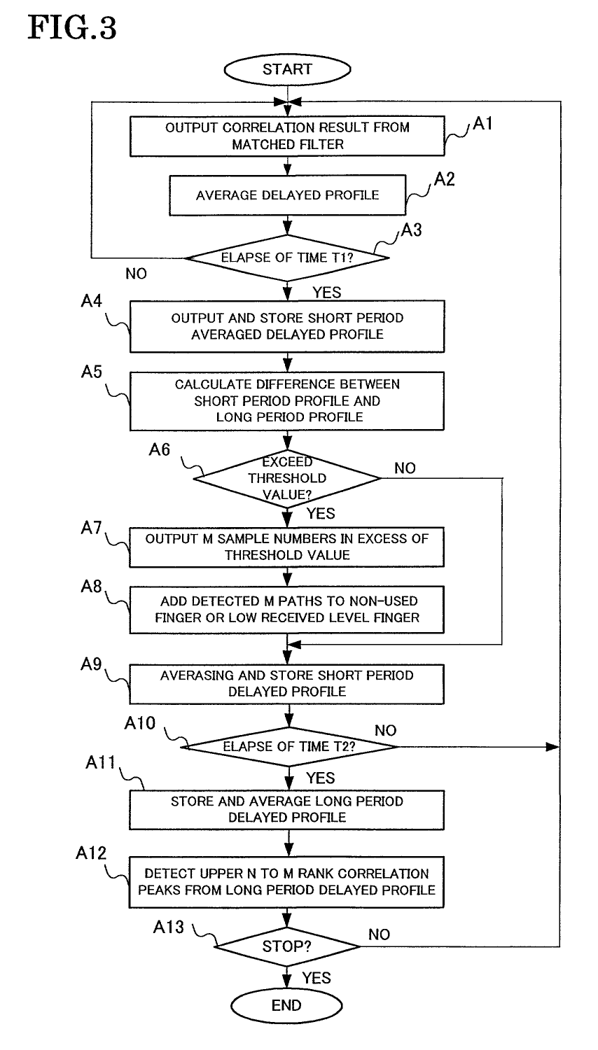

The detailed operation of the multi-path detecting circuit according to the present invention will now be described with reference to the flow chart shown in FIG. 3. The matched filter 11 executes instantaneous delayed profile profile measurement by calculating the correlation of spread codes and received signal to one another (step A1 ). This delayed profile is averaged for time T1 (for instance 10 msec.) such as to be able to smooth noise (step A2). A check is then performed as to whether the time T1 has elapsed (step A3). After the averaging for the time T1, the result of the short period averaging is outputted (step A4). The difference of the stored long period averaged delayed profile correlation data from the output data obtained in the step A4 is calculated or extracted for each sample (step A5). Then, a check is performed for each sample as to whether a predetermined threshold value has been exceeded (step A6). When the threshold value has been exceeded (“Yes” in step A6), M sample numbers in excess of the threshold value are outputted (step A7). A finger allotment determining part allots newly detected new pathes are allotted to the fingers presently out of use or in the order of lower reception power level fingers (step A8). The above operation is executed in a cycle period of time T1. Thus, the detected pathes can be added in the time T1.

The short period averaged delayed profile outputted in the step A4 is then averaged for longer period T2 of time (for instance 100 msec.) (step A9). A check is then performed as to whether time T2 has elapsed (step A10). The long period averaged delayed profile data is stored for every averaging period of the time T2 (step A11). Upper N to M rank correlation peaks of the stored profile are selected, and these timings are allotted to the fingers (step A12). N is the number of fingers, and M is the number of new peaks detected in the step A7. The above process is executed in a cycle period of the time T2. Thus, it is possible to obtain sufficient averaging of the path level variations due to fading and perform path allotment to the fingers in the order of higher average reception power level pathes. Finally, a check is performed as to whether the system has been inoperative (step A13). When “Yes” is yielded in the step A13, an end is brought to the routine. When “No” is yielded in the steps A10 and A13, the routine goes back to the step A1 noted above.

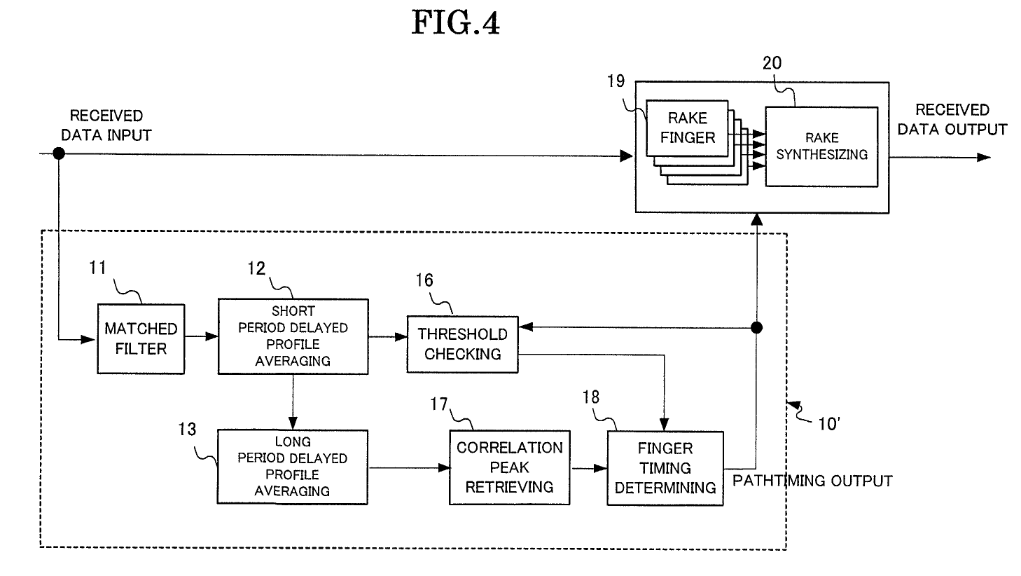

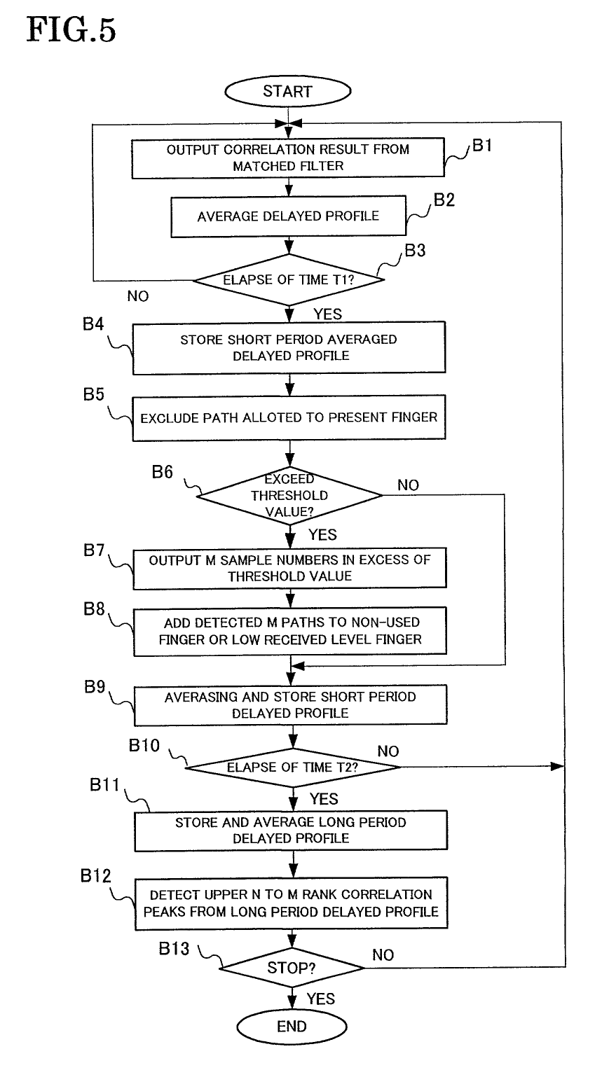

A different embodiment of the multi-path detecting circuit according to the present invention will now be described with reference to FIGS. 4 and 5. FIG. 4 is a block diagram showing the construction of the different embodiment. This embodiment is the same in the basic construction as the preferred or first embodiment shown in FIG. 1. In FIG. 4, parts corresponding to those on FIG. 1 are designated by like reference numerals. The multi-path detecting circuit 10′ shown in FIG. 4 is obtained by omitting the delayed profile storing part 14 and the subtracter 15 shown in FIG. 1 to reduce the necessary memory size. That is, the circuit 10′ comprises the matched filter 11, the short period delayed profile averaging part 12, the long period delayed profile averaging part 13, the threshold checking part 16, the correlation peak retrieving part 17 and the finger timing determining part 18.

The matched filter 11 receives received data input, and its output is inputted to the short period delayed profile averaging part 12. The short period delayed profile averaging part 12 is connected to the long period delayed profile averaging part 13 and the threshold checking part 16. The long period delayed profile delayed profile averaging part 13 is connected via the correlation peak retrieving part 17 to the finger timing determining part 18. The path timing output of the finger timing determining part 18 is inputted to the threshold checking part 16 and also to the RAKE finger part 19. The output of the RAKE finger part 19 is inputted to the RAKE synthesizing part 20, which in turn outputs received data output.

FIG. 5 is a flow chart for describing the operation of the multi-path detecting circuit 10′ shown in FIG. 4. The flow chart of FIG. 5, like the flow chart of FIG. 3, is constituted by steps B1 to B13, and main difference of the former chart from the later resides in that instead of the calculation of the difference between the long period averaged delayed profile data and the short period averaged data, the threshold checking part executes the threshold check by excluding the pathes presently allotted to the fingers and samples near the detected pathes from the short period delayed profile data (step B4). Thus, it is possible to detect only new pathes, and the same effects as in the embodiment shown in FIG. 1 are obtainable. In the FIG. 4 embodiment, the subtracting process on all the samples is simplified compared to the FIG. 4 embodiment. In addition, no long period averaged delayed profile storing part (or memory) is necessary.

As has been described in the foregoing, with the multi-path detecting circuit according to the present invention the following pronounced practical effects are obtainable. In the first place, sufficient averaging of level variations due to slow fading is possible by long period averaging even at a slow moving time. It is thus possible to preferentially select high average reception power level pathes. In addition, even in such case where the path existing positions is fast changes due to shadowing or like causes, it is possible to fast add path allotment to the fingers by the estimation from the short period delayed profile. It is thus possible to obtain multi-path detection reliability improvement independently of the moving status of the terminal. Furthermore, since the path selection from the short period delayed profile requires only subtraction and threshold checking, it is possible to reduce the circuit scale and the current consumption.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A multi-path detecting circuit for detecting multi-path timings by measuring a delayed profile of a propagation channel, comprising:
a short period delayed profile averaging part and a long period delayed profile averaging part for averaging the delayed profile in two different, i.e., short and long, cycle periods, respectively.

2. The multi-path detecting circuit according to claim 1, further comprising a threshold checking part for receiving the output of the short period delayed profile averaging part and checking whether the output exceeds a threshold value, a correlation peak retrieving part for receiving the output of the long period delayed profile averaging part and retrieving upper rank correlation peaks for every correlation profile, and a finger timing determining part for receiving the outputs of the correlation peak retrieving part and the threshold checking part.

3. The multi-path detecting circuit according to one of claims 1 and 2, comprising a long period profile storing part for storing the output of the long period delayed profile averaging part.

4. The multi-path detecting circuit according to claim 3, comprising a subtracter provided between the short period delayed profile averaging part and the threshold checking part, for extracting the difference of the short period averaged delayed profile from the long period averaged delayed profile stored in the long period delayed profile storing part for each short period averaged delayed profile.

5. The multi-path detecting circuit according to one of claims 1 to 4, wherein the short period is set to about 10 msec., and the long period is set to about 100 msec.

6. The multi-path detecting circuit according to one of claims 1 to 5, which is used for a CDMA receiver having a RAKE finger part, to which the timing output from the finger timing determining part is supplied.

7. A multi-path detecting system for determining pathes to be allotted to RAKE finger on the basis of combination of a long period averaged delayed profile for averaging level variations due to fading and a short period averaged delayed profile for fast detecting new path generation.

8. A multi-path detecting system comprising:
a matched filter for outputting correlation value data concerning spread code and received signal;
a short period delayed profile averaging part for averaging delayed profile of measured channel path;
a long period delayed profile averaging part for power averaging the short period averaged delayed profile data for a long period and storing the power averaged data to a long period delayed profile storing part;
a subtracter for subtracting a difference from the stored long period averaged delayed profile whenever the short period averaged delayed profile is outputted;
a threshold checking part for outputting data of pathes to be added when the difference from the subtracter exceeds a predetermined threshold value;
a finger timing determining part for adding path allotment to RAKE finger part on the basis of the output of the threshold checking part;
a correlation peak retrieving part for retrieving correlation peaks up to upper rank N for every long period delayed profile storing part output;
a finger timing determining part for alloting the path timings to the RAKE finger part; and
a RAKE synthesizing part for synthesizing data received in the individual fingers with each multi-path.

9. A multi-path detecting system comprising steps of:
executing instantaneous delayed profile measurement by calculating correlation of spread codes and received signal to one another;
averaging the delayed profile for time such as to be able to smooth noise;
checking as to whether the time has elapsed;
outputting the result of the short period averaging after the averaging for the time;
calculating the difference of the long period averaged delayed profile correlation data from the short period averaged data obtained for each sample;
checking, for each sample, as to whether a predetermined threshold value has been exceeded and, when the threshold value has been exceeded, outputting M sample numbers in excess of the threshold value;
alloting newly detected new pathes the fingers presently out of use or in the order of lower reception power level fingers. averaging the short period averaged delayed profile for longer period of time;
checking as to whether the longer time has elapsed;
storing the long period averaged delayed profile data for every averaging period of the longer time;
selecting upper N to M rank correlation peaks of the stored profile; and
alloting these timings to the fingers.

10. A CDMS receiver using the multi-path detecting circuit according to claim 1 comprising:
an antenna part for receiving radio transmitted data;
a high frequency signal receiving circuit for frequency converting the received signal;
an A/D converter part for converting the output of the high frequency signal receiving circuit from analog signal to digital signal;
the multi-path detecting circuit for receiving signal from the A/D converter part, detecting multi-path timing and determining the detected multi-path timing as reception timing input to RKE finger part; and
a RAKE synthesizing part for synthesizing data from the RAKE finger part as received at each timing.

11. A CDMS receiver using the multi-path detecting system according to claims 7-10 comprising:
an antenna part for receiving radio transmitted data;
a high frequency signal receiving circuit for frequency converting the received signal;
an A/D converter part for converting the output of the high frequency signal receiving circuit from analog signal to digital signal;
the multi-path detecting circuit for receiving signal from the A/D converter part, detecting multi-path timing and determining the detected multi-path timing as reception timing input to RKE finger part; and a RAKE synthesizing part for synthesizing data from the RAKE finger part as received at each timing.
